(19) United States
(12) Patent Application Publication
(10) Pub. No.: US 2008/0121830 A1
(43) Pub. Date: May 29, 2008

(54) Hydraulic control valve system

(75) Inventors: Thierry Martin, Maiche (FR); Alfonso Heredia, Les Fins (FR); Jean-Michel Meyer, Sonceboz (CH); Hubert Poinceau, Bienne (CH)

Correspondence Address: BAKER & DANIELS LLP, 300 NORTH MERIDIAN STREET, SUITE 2700, INDIANAPOLIS, IN, 46204, US

(73) Assignee: Societe Industrielle de Sonceboz S.A., Sonceboz (CH)

(21) Appl. No.: 11/604,432

(22) Filed: Nov. 27, 2006

(51) Int. Cl. F16K 31/04

(52) U.S. Cl. 251/129.11

(57) ABSTRACT

A hydraulic control valve system comprising a hydraulic valve block with a plurality of control valve segments arranged in a juxtaposed manner, each control valve segment comprising a first line, for example a pump line, a second line, for example a return line, and a displaceable valve rod adapted to open and close the first line, respectively close and open the second line to varying degrees depending on a position of the valve rod. The valve system further has a plurality of actuators arranged in a juxtaposed manner, one actuator for each valve segment, each actuator comprising an electrical motor connected to a respective said valve rod through a coupling mechanism. Each motor has a rotor and a stator, whereby a ratio DS/HS of an average diameter DS of coils of the stator divided by an overall height HS of the coils in a direction parallel to an axis of rotation of the rotor is greater than four.

### BACKGROUND OF THE INVENTION

This invention relates to a valve system for controlling a hydraulic drive system.

Hydraulic drive systems are used in many mechanical load applications, for example in construction equipment, farming equipment, fork lifts, cranes and other hydraulically driven work systems. Hydraulic pistons driving an associated mechanical organ are controlled by valves controlling the flow of hydraulic fluid through a pump line and a return line, in order to fill or to empty the hydraulic piston. The degree of opening and closing of the pump line, respectively return line control valves, determines the rate of displacement and position of the associated mechanical load member. It is therefore important to ensure accuracy in the opening and closing of the control valves and to reduce sensitivity of the control valve opening to pressure in the hydraulic system.

In certain conventional systems, hydraulic valves are controlled by means of electromagnetic actuators combined with a hydraulic amplifier to provide the required force to displace and to hold the valve rod. It is however difficult with such control systems to obtain precise and rigid control of the valves. Another known means of controlling valves is by way of an actuator comprising an electrical motor driving the valve control rod, as described in DE 19 948 379 or U.S. Pat. No. 4,650,159.

The use of a stepping motor to actuate a valve rod is advantageous in view of the high rigidity it confers to the hydraulic valve control system as well as enabling high precision in the opening and closing of the valves through control of the stepping motor. A major disadvantage of such systems is however the size of the stepping motor and the limited number of hydraulic valves that may be arranged in a juxtaposed manner. In DE 19 948 379 for example, the hydraulic block has four pairs of control valves mounted in a juxtaposed manner, each control valve being actuated by an electrical stepping motor connected to the valve rod via a link arm, each of the motors being arranged in a different orientation. In this configuration, additional valves cannot be added to the valve block and the different arrangements of the various electrical motors increases manufacturing and assembly costs.

### SUMMARY OF THE INVENTION

In view of the aforegoing, it is an object of the invention to provide a hydraulic control valve system with a plurality of juxtaposed valves that is compact, economical to manufacture and assemble, and that provides precise and rigid control of the opening and closing of the hydraulic valves.

It is a further object of this invention to provide a hydraulic control valve system that may be easily expanded to include more control valves in a juxtaposed manner in a compact block.

Objects of this invention have been achieved by providing a hydraulic control valve system comprising a hydraulic valve block with a plurality of control valve segments arranged in a juxtaposed manner, each control valve segment comprising a first line, for example a pump line, a second line, for example a return line, and a displaceable valve rod adapted to open and close the first line, respectively close and open the second line to varying degrees depending on a position of the valve rod, the valve system further comprising a plurality of actuators arranged in a juxtaposed manner, one actuator for each valve segment, each actuator comprising an electrical motor connected to a respective said valve rod through a coupling mechanism, each motor having a rotor and a stator, whereby a ratio DS/HS of an average diameter DS of coils of the stator divided by an overall height HS of the coils in a direction parallel to an axis of rotation of the rotor is greater than two.

Advantageously, the actuator has width equal or smaller than each hydraulic valve segment such that a plurality of identical actuators can be assembled in a juxtaposed manner to actuate a plurality of respective hydraulic valves in a compact valve block while benefiting from the positional rigidity and control accuracy of the electrical motor.

The coupling mechanism of the actuator may advantageously comprise a rack and pinion, the rack fixed directly to or forming an extension of the valve rod.

The electrical motor may advantageously be a stepping motor, the stator comprising a plurality of coils positioned around radially extending arms of the stator. The stator preferably comprises at least six coils, preferably eight. In view of obtaining high accuracy and rigidity when displacing the valve rod, the motor preferably has a large number of steps per revolution, preferably more than 100, for example around 200 steps. The large number of steps is also particularly advantageous in providing a very low positional hysteresis when changing drive direction. In the embodiment shown, the rotor has around 50 teeth.

Further objects and advantageous features of the invention will be apparent from the claims and the following detailed description and figures.

### BRIEF DESCRIPTION OF THE DRAWINGS

FIG. 1a is a view of a hydraulic control valve system according to this invention;

FIG. 1b is a view in the direction of arrow 1b of FIG. 1a;

FIG. 1c is a view in the direction of arrow 1c of FIG. 1b;

FIG. 2a is a cross-sectional view through line 2a-2a of FIG. 1a;

FIG. 2b is a cross-sectional view through line 2b-2b of FIG. 2a;

FIG. 3a is a cross-sectional view similar to FIG. 2a, except that it shows a variant of the electrical actuator;

FIG. 3b is a cross-sectional view through line 3b-3b of FIG. 3a;

FIG. 4a is a cross-sectional view similar to FIG. 2a except that it shows yet another variant of an electrical actuator;

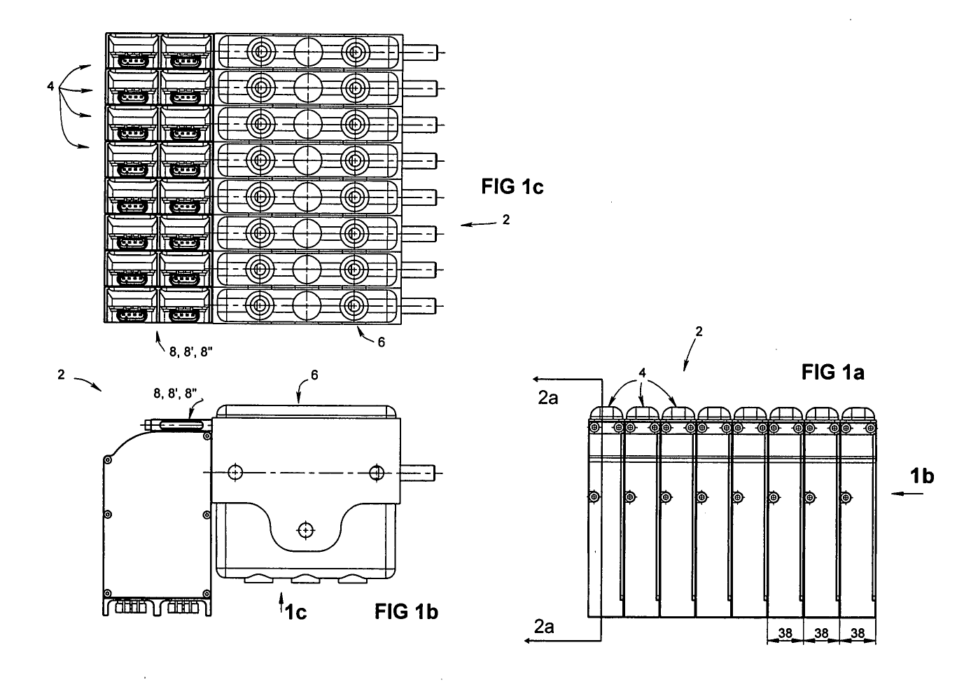

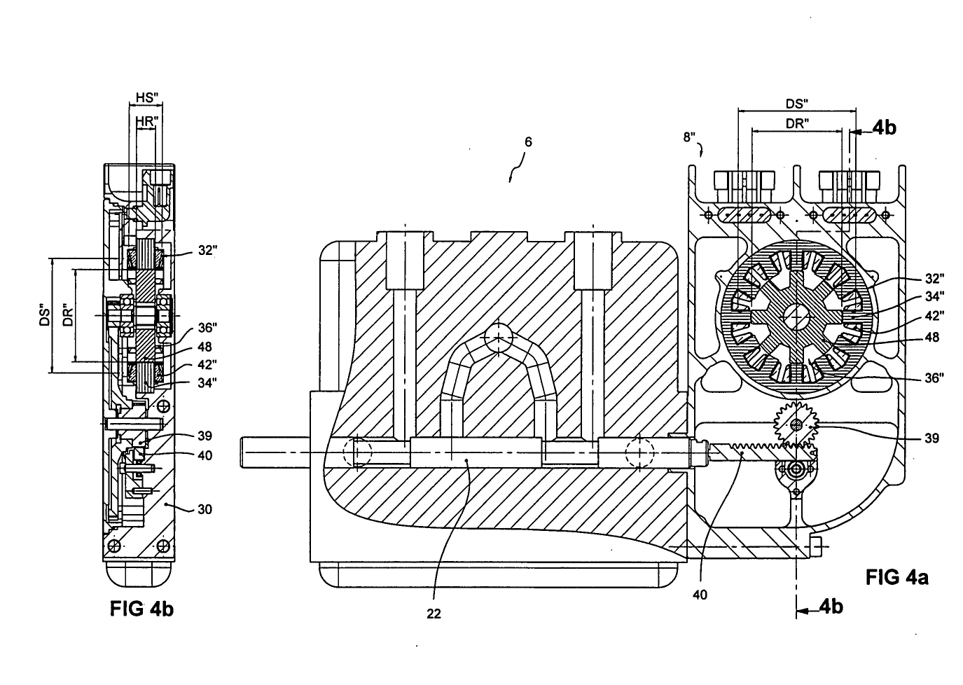

and FIG. 4b is a cross-sectional view through line 4b-4b of FIG. 4a.

### DETAILED DESCRIPTION

Referring to the figures, a hydraulic control valve system 2 comprises a plurality of juxtaposed hydraulic control valve segments 4, each segment comprising a hydraulic valve device 6 and an actuator 8, 8′, 8″. The hydraulic valve devices of the control valve segments may be provided as separate components assembled together to form a single block or alternatively may be made out of a single block or out of a number of components assembled together as a single block. Each hydraulic valve device comprises a body portion 10 within which are provided channels 12, 14, 16, 17, 19 through which hydraulic fluid flows.

The channels include a first channel 12 and a second channel 14 that are intended to be connected to hydraulic lines leading to a hydraulic piston for driving a mechanical load. The channels further include input channels 17, 19 intended to be connected to a hydraulic pump system that provides the hydraulic pressure, and an evacuation channel 16 for return of hydraulic fluid. The first and second channels 12, 14 may be connected respectively to a first line (such as a pump line) and a second line (such as a return line).

The hydraulic valve further comprises a valve rod 22 slidably mounted in a valve rod cavity 28 that communicates with the channels 12, 14, 16, 17, 19. The valve rod has reduced cross-section portions to interconnect or to disconnect the first line, respectively second line, with the input channels 17, 19 so as to open and close the first line 12 or the second line 14, for forward or reverse movement of the hydraulic piston connected thereto.

The position of the valve rod in the cavity determines how much the valves are opened or closed which in turn varies the pressure and flow of hydraulic fluid to or from the hydraulic drive system connected to the valve. It is therefore important to have an accurate displacement and positioning of the valve rod, as well as a high rigidity in holding and stabilizing the valve rod in any given position. This accurate positioning and rigid holding of the valve rod is provided by the actuator 8, 8′, 8″ which comprises a housing 30 assembled to the hydraulic valve body 10.

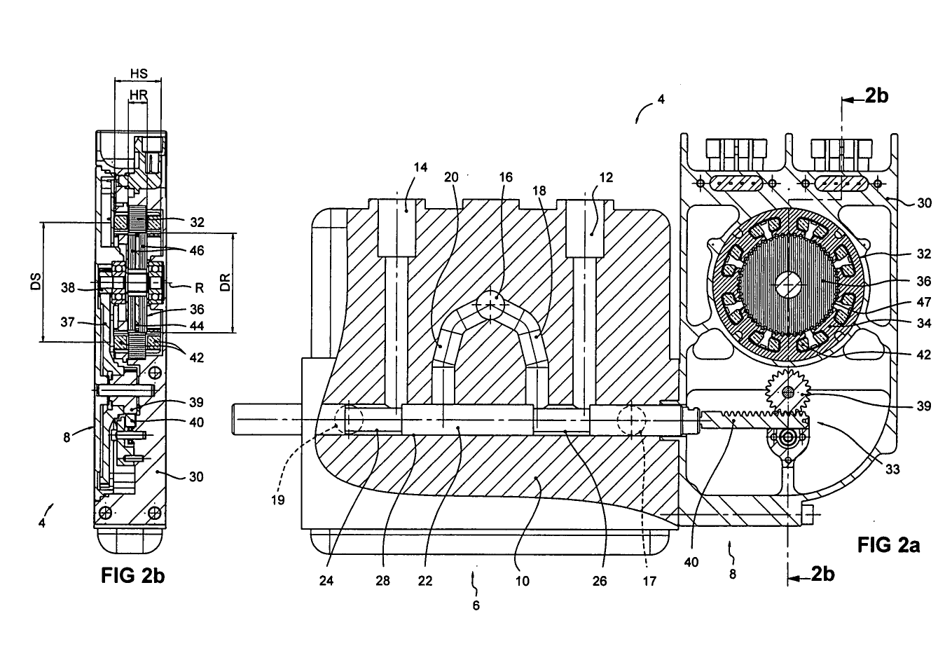

The actuator comprises an electrical motor, coupled to the valve rod via a coupling mechanism 33. The motor comprises a stator 32, 32′, 32″ rigidly fixed to the housing 30, and a rotor 36, 36′, 36″ rotatably mounted via bearings to the stator or housing. The coupling mechanism comprises a rotor gear 38 (FIG. 2b) rigidly fixed to the rotor engaging an intermediate gear wheel 37 driving a pinion 39. Instead of the intermediate gear wheel 37, it is also possible to have a transmission belt around the rotor gear 38 and pinion 39. The pinion engages a toothed rack 40 that is coupled to a valve rod 22, or alternatively is integrally formed with the valve rod.

The stator of the electrical motor comprises a plurality of coils 42 for generating a varying magnetic field that drives the rotor. In the embodiment shown, in FIGS. 2a and 2b, the motor is a stepping motor. The rotor comprising a permanent magnet 44 in a shape of a disc sandwiched between a pair of ferro-magnetic discs 46. The stator preferably comprises at least six coils 42 arranged around the circumference of the rotor, mounted on radially extending stator arms 34.

In view of obtaining high accuracy and rigidity when displacing the valve rod, the motor preferably has a large number of steps per revolution, preferably more than 100, for example around 200 steps. The large number of steps is also particularly advantageous in providing a very low positional hysteresis when changing drive direction. Both the rotor and the stator of the stepping motor preferably have a large number of teeth 47, preferably more than 40. The stator of the stepping motor embodiment preferably has at least six coils, but preferably eight or more.

The ratio DS/HS of the average diameter DS of the stator coils with respect to the overall height HS of the coils is advantageously greater than 2, possibly 2.2, and preferably 2.4 or more. The ratio DR/HR of the diameter DR of the rotor discs with respect to its axial height HR, the height being measured in the direction of the axis of rotation R, is preferably greater than 4 and preferably 5 or more. The aforementioned ratios enable the actuator to have the same width or less than the width of conventional hydraulic valve segments, which are typically around 40 mm wide, while providing the required torque and stability for driving the valve rod under typical pressures found in valve control systems for agricultural equipments, fork lifts, construction equipment and the like. The actuators may thus be assembled in an identical and juxtaposed manner to any plurality of hydraulic valve segments of a hydraulic valve block.

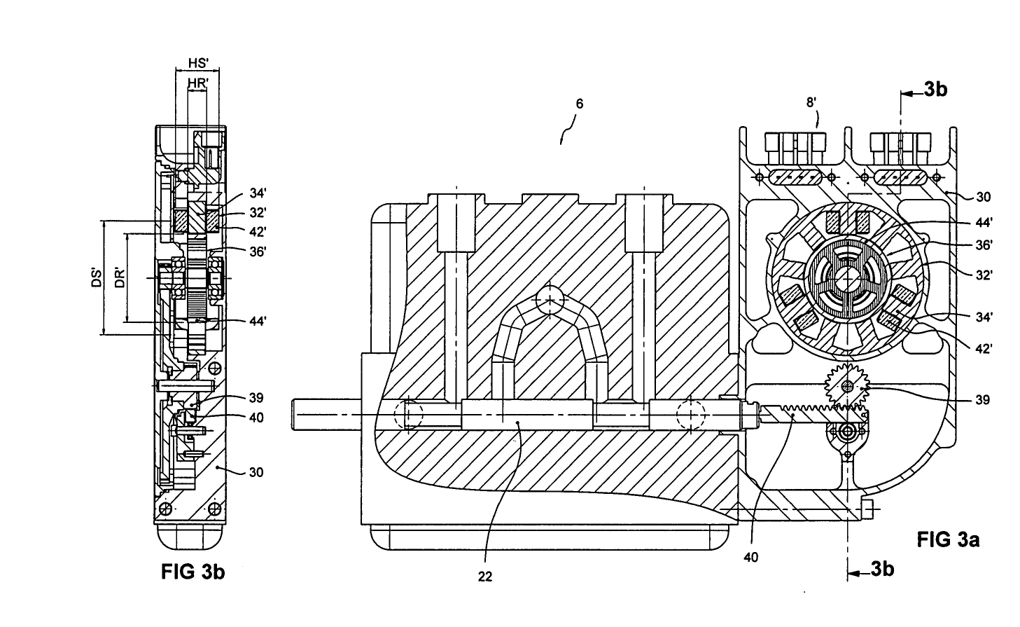

In the embodiment shown in FIGS. 3a and 3b, the motor of the electrical actuator is a brushless DC motor comprising a ferro-magnetic stator 32′ with a plurality of radially and inwardly directed stator arms or poles 34′. The coils 42′ are mounted in a spaced apart manner around the periphery of the rotor on certain of the poles 34′. The rotor 36′ comprises an annular permanent magnet 44′ that has a plurality of adjacent alternately polarized segments.

The brushless DC motor generates a lower torque than the stepping motor, but the rotor rotates at a higher speed such that the gear down ratio of the gear system acting on the rack 40 has a greater ratio than the gearing down mechanism of the stepping motor actuator. In view of the higher gearing down, reversibility of the hydraulic system (in the situation where the electric motor is switched-off) is not as good as with the stepping motor. Certain applications however do not require reversibility in the case of a power failure or for other reasons but on the contrary reversibility may not be desired.

Referring now to FIGS. 4a and 4b, another embodiment is shown in which the electrical actuator comprises a variable reluctance motor comprising a ferro-magnetic stator 32″ having a plurality of radially and inwardly directed stator arms or poles 34″ around which coils 42″ are mounted. In the case of a variable reluctance motor, the rotor 36″ comprises a ferro-magnetic body with a plurality of radially and outwardly directed poles 48, there being less rotor poles than stator poles. The stator coils generate a varying magnetic field that generates the equivalent of a rotating magnetic field attracting the rotor poles 48. In view of the fact that the variable reluctance motor does not generate any magnetic resistance when the electrical supply is switched off, the motor has a high reversibility and may therefore advantageously be used in applications where reversibility is desired.

1. A hydraulic control valve system comprising a hydraulic valve block with a plurality of control valve segments arranged in a juxtaposed manner, each control valve segment comprising a first line, a second line, and a displaceable valve rod adapted to open and close the first line, respectively close and open the second line to varying degrees depending on a position of the valve rod, the valve system further comprising a plurality of actuators arranged in a juxtaposed manner, one actuator for each valve segment, each actuator comprising an electrical motor connected to a respective said valve rod through a coupling mechanism, each motor having a rotor and a stator, whereby a ratio DS/HS, DS′/HS′, DS″/HS″ of an average diameter DS, DS′, DS″ of coils of the stator divided by an overall height HS, HS′, HS″ of the coils in a direction parallel to an axis of rotation of the rotor is greater than two.

2. Hydraulic control valve system according to claim 1 wherein the ratio DS/HS, DS′/HS′, DS″/HS″ is greater than 2.2.

3. Hydraulic control valve system according to claim 1 wherein the ratio DS/HS, DS′/HS′, DS″/HS″ is greater than 2.4.

4. Hydraulic control valve system according to claim 1 wherein the coupling mechanism comprises a rack extending from the valve rod, engaging a pinion mounted in the actuator and driven by the rotor.

5. Hydraulic control valve system according to claim 1 wherein the hydraulic valve block comprises more than four juxtaposed hydraulic control valve segments and associated actuators.

6. Hydraulic control valve system according to claim 1 wherein the motor is a stepping motor and the stator comprises six or more coils arranged on radially extending arms of the stator.

7. Hydraulic control valve system according to claim 6 wherein the stator comprises at least eight coils.

8. Hydraulic control valve system according to claim 1 wherein the motor is a brushless DC motor.

9. Hydraulic control valve system according to claim 1 wherein the motor is a variable reluctance motor.
